(19) United States
(12) Patent Application Publication
(10) Pub. No.: US 2003/0160851 A1
(43) Pub. Date: Aug. 28, 2003

(54) Inkjet printed textiles with improved durability

(76) Inventors: Romeo A. Baccay, Acworth, GA (US); Waifong L. Anton, Wilmington, DE (US); Michael W. Raymond, Newark, DE (US)

Correspondence Address: E I DU PONT DE NEMOURS AND COMPANY, LEGAL PATENT RECORDS CENTER, BARLEY MILL PLAZA 25/1128, 4417 LANCASTER PIKE, WILMINGTON, DE, 19805, US

(21) Appl. No.: 10/364,165

(22) Filed: Feb. 11, 2003

Related U.S. Application Data
(60) Provisional application No. 60/356,263, filed on Feb. 12, 2002.

(51) Int. Cl. B41J 2/01

(52) U.S. Cl. 347/101; 347/102; 399/328

(57) ABSTRACT

This invention pertains to a method for inkjet printing of textiles and the post treatment thereof for improved durability, in particular to post treatment with a combination of heat and pressure for improved crock-fastness.

### CROSS-REFERENCE TO RELATED APPLICATION

This application claims priority under 35 U.S.C. §119 from U.S. Provisional Application Serial No. 60/356,263 (filed Feb. 12, 2002), which is incorporated by reference herein as if fully set forth.

### FIELD OF THE INVENTION

This invention pertains to a method for inkjet printing of textiles and the post treatment thereof for improved durability, in particular to post treatment with a combination of heat and pressure for improved crock-fastness.

### BACKGROUND OF THE INVENTION

The printing of textiles is currently accomplished primarily by rotary screen methods. In operation, screen printing is rapid and, for large runs, cost effective. However, cutting screens is expensive and time consuming thus making the per-unit cost for short runs quite substantial and, in many cases, prohibitive.

A digital printing method such as inkjet printing offers a number of potential benefits over conventional screen printing methods. Digital printing eliminates the set up expense associated with screen preparation and can potentially enable cost-effective short run production.

Inkjet printing furthermore allows visual effects such as tonal gradients and infinite pattern repeat size that cannot be practically achieved by a screen printing process.

One such digital printing system for textiles is disclosed in commonly owned U.S. Ser. No. 10/264859 (filed Oct. 4, 2002) (claiming priority from U.S. Provisional Application No. 60/327,119, filed Oct. 4, 2001), which is incorporated by reference herein for all purposes as if fully set forth.

However, inkjet printing as it exists today is disadvantageous because of relatively slow speed. To be competitive with screen printing even for short runs, the speed of inkjet printers needs to increase.

Another disadvantage of inkjet printing, in particular inkjet printing with pigmented ink, is inkjet printed fabrics are particularly susceptible to color removal by abrasion and thus have poor durability or crock-fastness.

Even as inkjet hardware improvements are made to increase printing speeds, adoption of inkjet printing in the textile industry will be impeded if methods to also improve crock-fastness are not found.

U.S. Pat. No. 4,597,794 discloses inkjet ink formulations suitable for textile. Fabrics were imaged with this ink and set by heating at 150° C. for five minutes. Wash-fastness was described as excellent.

U.S. Pat. No. 5,897,694 discloses inkjet ink formulations comprising, as an additive, a transition metal chelate, which provides improved wash-fastness.

U.S. Pat. No. 5,958,561 discloses an ink/textile combination wherein the textile is pretreated with a cross-linkable thermoplastic polymer and then imaged with an aqueous ink and cured at temperatures of 100-190° C. Improved wash-fastness was obtained.

U.S. Pat. No. 6,146,769 discloses an ink/textile combination wherein an interactive polymer, in the ink or pretreated or on the textile, helps bind the particulate colorant and provide wash-fastness.

US2002/0130939 describes a printer provided with a pressure/heater roller device for post processing of printer output, but primarily only addresses the mechanical aspects of post processing for paper print media.

Japanese laid open patent Hei 9-143407 discloses an inkjet ink with a thermoset resin which is imaged on fabric and fixed by heating at 130° C. The image is said to be water resistant.

Japanese laid open patent Hei 8-283636 discloses an inkjet ink with specified resin emulsions having high Tg. Fabric imaged with this ink is fixed at elevated temperature to provide wash-fastness.

All of the above are incorporated by reference herein for all purposes as if fully set forth.

Still, there is need in the art for improved durability of inkjet images on textile, especially in cases where the colorant is pigment.

It is thus an object of this invention to provide inkjet printed textiles with good crock-fastness.

### SUMMARY OF THE INVENTION

It was found that the crock-fastness of an inkjet-printed textile could be improved to a commercially acceptable level by treating the printed textile with a combination of heat and pressure.

Accordingly, there is provided a method for inkjet printing of a textile, the method comprising the steps of inkjet printing an ink jet ink onto a textile substrate to produce an inkjet-printed textile, and treating the inkjet-printed textile with a fusing operation by applying a combination of heat and pressure.

There is also provided an improved method for inkjet printing of a textile, the method comprising inkjet printing an ink jet ink onto a textile substrate to produce a, inkjet-printed textile, wherein the improvement comprises treating the printed textile with a combination of heat and pressure.

There is also provided a method for improving the durability of an inkjet-printed textile comprising the step of treating said inkjet printed textile with a fusing operation.

As used in the context of the present invention, “fusing” or “fusion” refers to the simultaneous application of heat and pressure. This use in the context of the present invention may be considered to vary slightly from the traditional dictionary definition of the terms.

The fusion, in accordance with the present invention, can be performed in-line with the inkjet printer or performed separately, off-line.

The instant method is particularly advantageous for improving the durability of textiles printed with pigmented inkjet inks, and allows the achievement of commercially acceptable durability for pigmented ink jet ink printed textiles. Thus, another aspect of the present invention is a textile printed with a pigmented ink, said printed textile having a dry crock-fastness of at least 4 and a wet crock-fastness of at least 3 (as measured in accordance with AATCC Test Method 8).

These and other features and advantages of the present invention will be more readily understood by those of ordinary skill in the art from a reading of the following detailed description. It is to be appreciated that certain features of the invention which are, for clarity, described above and below in the context of separate embodiments, may also be provided in combination in a single embodiment. Conversely, various features of the invention that are, for brevity, described in the context of a single embodiment, may also be provided separately or in any subcombination.

### BRIEF DESCRIPTION OF THE DRAWINGS

FIG. 1 depicts an embodiment of the present invention wherein the fusion of the inkjet-printed fabric is accomplished by treatment with heated nip rollers.

FIG. 2 depicts another embodiment of the present invention wherein the fusion is accomplished by heating the inkjet printed fabric with a heated platen or a radiant heater, or a combination of the two, and immediately applying pressure to the warm fabric with nip rollers.

FIG. 3 depicts a Glenro-type fuser wherein the printed textile is transported on a continuous belt through an oven-like heating zone to bring it up to fusion temperature; at the end of this zone the textile and the upper and lower belts are nipped with rollers such that pressure is applied to the heated textile.

### DETAILED DESCRIPTION OF THE PREFERRED EMBODIMENTS

The instant method is applicable to textiles printed with any inkjet printer. Suitable commercially available inkjet printers designed for textile include, for example, DuPont 3210 and 2020 Textile Printers (DuPont, Wilmington, Del.), Textile Jet (Mimaki USA, Duluth, Ga.), DisplayMaker Fabrijet (MacDermid ColorSpan, Eden Prairie, Minn.), Amber, Zircon and Amethyst (Stork®) and the like.

The inkjet inks can be any inks suitable for textile, especially those suitable for jetting in the aforementioned and similar printers. Preferably, the inks are pigmented. Suitable inks also include those in the aforementioned incorporated references, such as in U.S. Ser. No. 10/264859 (filed Oct. 4, 2002) (claiming priority from U.S. Provisional Application No. 60/327,119, filed Oct. 4, 2001). See also EP-A-1158029 (incorporated by reference herein for all purposes as if fully set forth).

Pigment ink formulations for textiles will typically contain binder. Binders will preferably have a softening point (as indicated by glass transition temperature, Tg, or minimum film forming temperature, MFT) of less than about 60° C., more preferably less than about 30° C. and even more preferably less than about 20° C. Binders with higher softening points tend to be harder to the touch and when incorporated in textile, cause the feel to be rough. The feel of a textile is referred to as the “hand”. Generally, a softer hand is preferred.

Textiles useful in this invention include, but are not limited to cotton, wool, nylon, polyester and the like, and blends thereof. The finished form of the textile includes, but is not limited to, fabrics, garments, furnishings such as carpets and upholstery fabrics, and the like. Textiles can contain natural and synthetic materials, and blends thereof, and can be treated or untreated as is known in the art.

The printed textile is fused at elevated temperature and pressure. Upper temperature is dictated by the tolerance of the particular textile being printed. Lower temperature is determined by the amount of heat needed to achieve the desired level of durability. Generally, fusion temperatures will be at least about 80° C. and preferably at least about 100° C., more preferably at least about 140° C. and most preferably at least about 160° C.

Fusion pressures required to achieve improved crock can be very modest. Thus, pressures can be about 3 psi, preferably at least about 5 psi, more preferrable at least about 8 psi and most preferably at least about 10 psi. Fusion pressures of about 30 psi and above seem to provide no additional benefit to crock, but such pressures are not excluded.

The duration of fusion (amount of time the printed textile is under pressure at the desired temperature) was not found to be particularly critical. Most of the time in the fusion operation generally involves bringing the print up to the desired temperature. Once the print is fully up to temperature, the time under pressure can be brief (seconds).

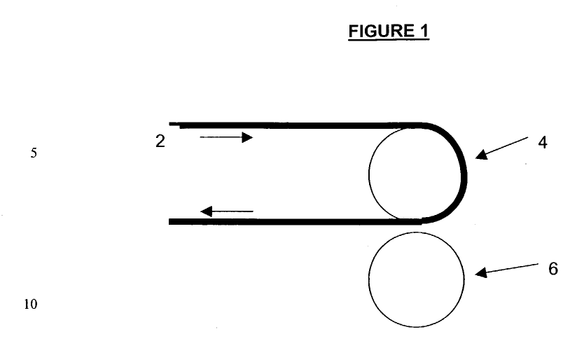

Referring to FIG. 1, there is depicted an embodiment wherein the fusion of the inkjet printed fabric is accomplished by treatment with heated nip rollers. The printed textile 2 is transported, under tension, over a heated roller 4 of sufficient diameter to provide adequate contact time at a given transport speed to allow temperatures reach desired levels. A second roller 6, covered with temperature resistant, pliant materials (e.g. silicone rubber), applies pressure to the heated print by nipping it against the heated roller 4.

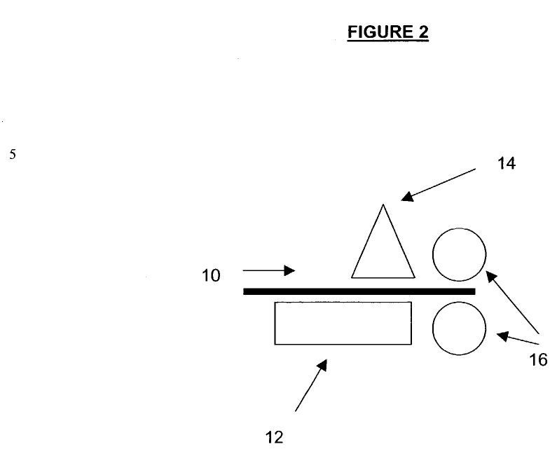

Referring to FIG. 2, there is depicted another embodiment wherein the fusion is accomplished by heating the inkjet printed fabric 10 with a heated platen 12 or a radiant heater 14, or a combination of the two, and immediately applying pressure to the warm fabric with nip rollers 16. The print is maintained at fusion temperature during application of pressure.

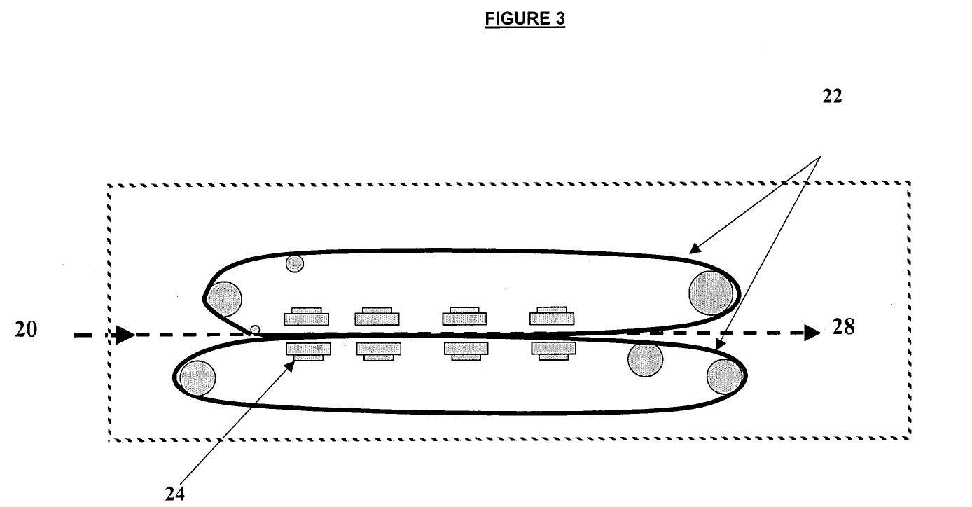

Referring to FIG. 3, the printed textile 20 is transported on a continuous belt through an oven-like heating zone 24 to bring it up to fusion temperature; at the end of this zone the textile and the upper and lower belts are nipped with rollers 22 such that pressure is applied to the heated textile 28.

In yet another embodiment (not depicted) printed textile is placed, in a batch process, between two flat, parallel platens which are heated to fusing temperature and pressed together to achieve the desired fusion pressure.

The size of any fusion apparatus is dictated by the dimension of the fabric being treated. Typically fabric will be printed in rolls with widths of from 1 to 3 meters and thus the fusion zone of a fusion apparatus will preferably accommodate widths in that range.

From the viewpoint of commercial operation, the fusion operation is preferably performed in a continuous mode, although batch operation is also operable. The fuser can be positioned in-line with the inkjet printer such that the printed textile is fused immediately after printing. Alternatively, the fuser can be positioned off-line such that the printed textile is collected after printing and separately subjected to fusing.

With current technology, the fusing operation can be performed at faster rates than the textile can be inkjet-printed. Thus, an off-line fusing apparatus could potentially handle output from more than one inkjet printer. An in-line fusing apparatus would operate at the same rate as the printer.

### EXAMPLES

Inkjet printers and inks used in the following examples were 1) a DuPont Ink Jet 3210 printer and associated pigmented inks available under the Artistri™ tradename (P874 Cyan, P813 Magenta, P845 Yellow, P893 Black, P834 Orange, P869 Green); and, 2) an Epson Stylus® C80 printer and associated pigment inks available under the tradename Durabrite™ (T0323 magenta and T0322 cyan).

The fabrics used were obtained from Testfabrics, Inc., namely 1) 100% cotton fabric style #419W which is a, bleached, mercerized combed broadcloth (133×72); and, 2) Polyester/cotton fabric, style #7436M which is a 65/35 poplin, mercerized and bleached.

Two different fusing apparatus were employed: 1) a Glenro (Paterson, N.J.) Bondtex™ Fabric and Apparel Fusing Press which moves the printed fabric between two heated belts equipped with adjustable pneumatic press and finally through a nip roller assembly; and, 2) a platen press, assembled for the purpose of precisely controlling temperature and pressure.

It should be noted that the Glenro Bondtex™ Fabric and Apparel Fusing Press is advertised for use in flatbed laminating of two or more layers of substrate materials. This operation of this unit, therefore, has been adapted for the fusion process of the present invention.

The platen press comprised of two parallel 6″ square platens with embedded resistive heating elements that were set to maintain a desired platen temperature. The platens were fixed in a mutually parallel position to a pneumatic press that could press the platens together at a desired pressure by means of adjustable air pressure. Care was taken to be sure the platens were aligned so as to apply equal pressure across the entire work piece being fused. The effective area of the platen could be reduced, as needed, by inserting a spacer (made, for example from silicone rubber) of appropriate dimensions to allow operation on smaller work pieces.

Crock-fastness was determined according to the procedure described in AATCC Test Method 8 (Research Triangle Park, N.C.).

According to this method, a piece of test fabric supplied expressly for this evaluation is affixed to a ‘finger’ on the crocking device. The fabric-covered finger is then put in contact with the inkjet-printed textile, under prescribed pressure, and driven repetitively across the fabric a prescribed number of times. Crock is assessed by measuring the amount of color transferred from the printed sample to the test fabric. Measurement can be done visually by estimating the color transfer compared to a standard AATCC scale. Measurement can also be done instrumentally with a spectrophotometer, for example a Minolta Spectrophotometer CM-3600d interfaced with SpectraMatch Version (V.3.3.5 D) and Color Sensor (version: 203,13011028) software from CyberChrome, Inc.

Two crock measurements were taken, one with dry test fabric (called Dry Crock) and one with the test fabric moistened with de-ionized water (called Wet Crock).

A crock rating scale of 1 to 5 was applied, wherein 5 denotes negligible or no change, 4 denotes slightly changed, 3 denotes noticeably changed, 2 denotes considerably changed, and 1 denotes much change in color. A difference of 0.5 units is considered significant and would be evident to most observers.

Commercially acceptable minimum values are generally considered to be 4 for dry crock and 3 for wet crock.

### Example 1

This example demonstrates the improved crock-fastness obtained for samples of Artistri™ ink, printed on the DuPont printer at 100% coverage (about 15 grams, wet weight, of ink per square meter of fabric) and fused with the Glenro press. The press was operated with the top and bottom rollers set for a temperature of 180° C. (actual temperature achieved on fabric surface cannot be determined), nip rollers set point for a pressure of 90 psia, (actual pressure achieved on fabric surface could not be accurately determined) a web speed of 3 ft/min and a dwell time of 53 seconds in the heating/treatment area.

Table 1 provides crock values (visual estimation) for inventive samples compared to ambient drying and to drying in an oven at 140° C. for 30 minutes (no pressure). Fabric was 419W cotton.

TABLE 1

| | Dry Crock | | | Wet Crock | | |
|---|---|---|---|---|---|---|
| Artistri | Ambient | Oven | Fusing | No | Oven | Fusing |
| Inks | Drying | Drying | Press | Drying | Drying | Press |
| Cyan | 3.0 | 4.0 | 4.5 | 1.5 | 3.0 | 3.0 |
| Magenta | 3.0 | 3.5 | 4.5 | 1.5 | 3.0 | 3.0 |
| Yellow | 3.0 | 3.0 | 4.5 | 1.5 | 2.5 | 2.5 |
| Black | 2.5 | 2.5 | 4.5 | 1.5 | 2.5 | 2.5 |
| Orange | 3.0 | 3.0 | 4.0 | 1.5 | 2.5 | 3.0 |
| Green | 4.5 | 3.0 | 5.0 | 2.5 | 3.5 | 3.5 |

Results indicate that application of fusion substantially improves dry crock over heating alone or no heat at all. For wet crock, similar improvement over ambient drying is obtained for either oven drying or fusion. However, oven drying would be impracticably slow for commercial purposes.

### Example 2

This example demonstrates the improved crock-fastness obtained for samples Artistri™ cyan ink, printed on the DuPont printer (100% coverage) and fused with the platen press. All crock measurements were spectrophotometric.

Table 2A provides crock values for inventive samples fused at the indicated temperatures, pressures, and duration compared to control samples allowed to dry under ambient conditions (no heat, no pressure, four replicates). Application of fusion improves crock. There was little sensitivity to the range of fusing pressures, 30-90 psi, and durations, 30-90 seconds, studied.

TABLE 2A

| | Fusion | | | | | 7436M | |
|---|---|---|---|---|---|---|---|
| | | | Dura- | 419W cotton | | cotton/poly | |
| | Temp. | Pres. | tion | Dry | Wet | Dry | Wet |
| Trial | (° C.) | (psi) | (sec) | Crock | Crock | Crock | Crock |
| 1 | 140 | 30 | 90 | 3.89 | 2.61 | 4.3 | 3.2 |
| 2 | 140 | 70 | 90 | 4.63 | 2.65 | 4.07 | 2.76 |
| 3 | 140 | 50 | 60 | 4.53 | 2.63 | 4.22 | 2.82 |
| 4 | 140 | 30 | 30 | 4.4 | 2.54 | 3.72 | 2.62 |
| 5 | 140 | 70 | 30 | 4.39 | 2.48 | 4.26 | 3.13 |
| 6 | 160 | 30 | 60 | 4.29 | 2.5 | 4.19 | 2.9 |
| 7 | 160 | 50 | 60 | 4.34 | 2.89 | 4.24 | 3.27 |
| 8 | 160 | 50 | 30 | 4.53 | 2.64 | 4.32 | 2.97 |
| 9 | 160 | 50 | 90 | 4.51 | 2.68 | 4.16 | 3.07 |
| 10 | 160 | 70 | 60 | 4.69 | 3 | 4.67 | 3.43 |
| 11 | 180 | 30 | 90 | 4.32 | 2.78 | 4.01 | 3.17 |
| 12 | 180 | 30 | 30 | 4.25 | 3.05 | 4.32 | 2.96 |
| 13 | 160 | 50 | 60 | 4.36 | 2.66 | 4.39 | 3.01 |
| 14 | 180 | 50 | 60 | 4.54 | 2.99 | 4.45 | 2.94 |
| 15 | 180 | 70 | 90 | 4.69 | 2.77 | 4.65 | 3.24 |
| 16 | 180 | 70 | 30 | 4.69 | 3.01 | 4.48 | 3.35 |
| Control 1 | 0 | 0 | 0 | 4.2 | 1.79 | 2.95 | 2.2 |
| Control 2 | 0 | 0 | 0 | 4.32 | 1.8 | 3.35 | 1.82 |
| Control 3 | 0 | 0 | 0 | 3.17 | 1.56 | 3.36 | 1.86 |
| Control 4 | 0 | 0 | 0 | 3.11 | 1.48 | 2.72 | 1.7 |

Table 2B provides crock values for inventive samples fused at the indicated temperatures, pressures, and duration compared to control samples which a) were air dried then subjected to the indicated pressure and b) were oven dried at 160° C. for 30 min then cooled and subjected to pressure. Fabric was 419W cotton.

TABLE 2B

| | No heat - | | Oven (160° C./ | | | |
|---|---|---|---|---|---|---|
| Pres- | pressure only | | 30 min.) then cooled, | | Fusion (160° C. and | |
| sure | dry | | then pressure | | pressure for 60 sec.) | |
| (psi) | crock | wet crock | dry crock | Wet crock | dry crock | wet crock |
| 60 | 4.36 | 1.92 | 3.91 | 2.95 | 4.57 | 2.87 |
| 50 | 2.53 | 1.86 | 3.04 | 2.97 | 4.56 | 2.88 |
| 40 | 3.92 | 1.84 | 2.78 | 3.12 | 4.64 | 2.77 |
| 30 | 2.5 | 1.84 | 2.59 | 2.98 | 4.55 | 2.9 |
| 20 | 2.53 | 1.73 | 2.5 | 3.05 | 4.34 | 2.88 |
| 15 | 2.56 | 1.68 | 2.6 | 3.06 | 4.56 | 2.91 |
| 10 | 2.33 | 1.82 | 2.72 | 3.04 | 4.26 | 2.83 |
| 5 | 2.67 | 1.77 | 3.61 | 3.32 | 4.46 | 2.95 |
| 0 | 3.68 | 1.74 | 4.35 | 3.22 | — | — |

As can be seen from the results, application of fusion yields higher crock values compared to the control samples. Fusion pressures as low as 5 psi are effective.

There tends to be substantial variability in dry crock results when samples are not fused (witness the control samples). Each crock value is the result of only one test. Variation is attributed mostly to actual differences in the fabric, rather than the test method itself. Fusing not only improves crock, but also tends to reduce sample-to-sample variation.

Table 2C provides crock values for inventive samples fused 160° C. and 10 psi for 60 seconds. The time between printing and fusion was varied between 1 and 93 hours.

TABLE 2C

| Time between | | | |
|---|---|---|---|
| printing and fusion | | Dry Crock | Wet Crock |
| 1 | hour | 3.93 | 3.01 |
| 2 | hours | 3.51 | 3.13 |
| 3 | hours | 4.44 | 2.84 |
| 4 | hours | 3.88 | 2.8 |
| 5 | hours | 4.46 | 2.85 |
| 21 | hours | 4.28 | 2.91 |
| 22 | hours | 4.38 | 2.87 |
| 23 | hours | 4.21 | 2.86 |
| 24 | hours | 4.34 | 2.89 |
| 25 | hours | 4.4 | 2.84 |
| 26 | hours | 4.44 | 2.98 |
| 27 | hours | 4.47 | 3.02 |
| 28 | hours | 4.27 | 3.04 |
| 29 | hours | 4.53 | 3.07 |
| 93 | hours | 4.29 | 2.91 |

Results show that the high crock values (which come from fusion) can be achieved whether fusion is performed immediately after printing (such as an in-line operation) or days later (such as off-line operation).

### Example 3

This example demonstrates the improved crock-fastness obtained for samples of Durabrite™ cyan and magenta ink, printed on an Epson Stylus® C80 printer (100% coverage) and fused with the platen press. This ink and printer are designed for paper and not, per se, for textile. The textile had to be mounted on a substrate to enable transport through the printer.

Results, given in Table 3, show improved crock (spectrophotometric measurement) after fusing, although the magnitude of improvement is less than for previous examples that used ink specifically designed for textile.

TABLE 3

| | Fusion: | | | | | |
|---|---|---|---|---|---|---|
| | 60 seconds | | | | | |
| | at | | Epson cyan | | Epson magenta | |
| Fabric | ° C. | Psi | dry crock | wet crock | dry crock | Wet crock |
| 419W | No heat | 0 | 3.22 | 1.9 | 2.95 | 1.78 |
| cotton | 140 | 50 | 3.2 | 2.07 | 2.86 | 1.68 |
| | 160 | 50 | 3.09 | 1.96 | 2.75 | 1.69 |
| | 160 | 50 | 3.11 | 2.03 | 2.85 | 1.71 |
| | 180 | 50 | 3.43 | 2.31 | 2.94 | 1.73 |
| 7436M | No heat | 0 | 2.57 | 1.75 | 2.38 | 1.62 |
| poly/ | 140 | 50 | 3.14 | 2.07 | 2.76 | 1.77 |
| cotton | 160 | 50 | 3.1 | 2.05 | 2.79 | 1.76 |
| | 160 | 50 | 3.09 | 2.05 | 2.83 | 1.84 |
| | 180 | 50 | 3.3 | 2.28 | 2.84 | 1.89 |

1. A method for inkjet printing of a textile, the method comprising the steps of inkjet printing an ink jet ink onto a textile substrate to produce an inkjet-printed textile, and treating the inkjet-printed textile with a fusing operation by applying a combination of heat and pressure.

2. The method of claim 1, wherein the heat and pressure are applied simultaneously.

3. The method of claim 1, wherein heat is applied followed by the application of pressure.

4. The method of claim 1, wherein heat is applied at temperatures of at least about 80° C., and at least about 3 psi of pressure is applied.

5. The method of claim 1, wherein the inkjet-printed textile is printed with a pigmented inkjet ink.

6. The method of claim 1, wherein the fusing operation is in-line with an inkjet printer producing the inkjet-printed textile such that fusing is effected in a continuous mode as the textile is printed.

7. The method of claim 1, wherein the fusing operation is off-line such that the inkjet-printed textile is collected after printing and separately subjected to fusing.

8. The method of claim 5, characterized in that the heat and pressure are applied simultaneously, heat is applied at temperatures of at least about 80° C., and at least about 3 psi of pressure is applied.

9. The method of claim 8, wherein the fusing operation is in-line with an inkjet printer producing the inkjet-printed textile such that fusing is effected in a continuous mode as the textile is printed.

10. The method of claim 8, wherein the fusing operation is off-line such that the inkjet-printed textile is collected after printing and separately subjected to fusing.

11. The method of claim 5, characterized in that heat is applied followed by the application of pressure, heat is applied at temperatures of at least about 80° C., and at least about 3 psi of pressure is applied.

12. The method of claim 11, wherein the fusing operation is in-line with an inkjet printer producing the inkjet-printed textile such that fusing is effected in a continuous mode as the textile is printed.

13. The method of claim 11, wherein the fusing operation is off-line such that the inkjet-printed textile is collected after printing and separately subjected to fusing.

14. A textile printed with a pigmented ink, said printed textile having a dry crock-fastness of at least 4 and a wet crock-fastness of at least 3 (as measured in accordance with AATCC Test Method 8).
